(19) United States
(12) Patent Application Publication
(10) Pub. No.: US 2014/0259623 A1
(43) Pub. Date: Sep. 18, 2014

(54) ELECTRICAL CONDUIT FITTING

(71) Applicant: Don Kinsman, Wareham, MA (US)

(72) Inventor: Don Kinsman, Wareham, MA (US)

(21) Appl. No.: 14/211,437

(22) Filed: Mar. 14, 2014

Related U.S. Application Data
(60) Provisional application No. 61/799,712, filed on Mar. 15, 2013.

(51) Int. Cl. F16L 21/08; F16L 21/00

(52) U.S. Cl. CPC F16L 21/08; F16L 21/00
USPC 29/525.01; 285/24

(57) ABSTRACT

In one embodiment, an electrical conduit fitting, comprises a cylindrical portion having an inside surface and an outside surface; at least one tapered end tapering outwardly such that the circumference of the tapered end is larger than the circumference of the outside surface of the cylindrical portion; and a spring band affixed to the cylindrical portion and to the tapered portion of the fitting.

### CROSS-REFERENCE TO RELATED APPLICATION

This application is based on and claims priority from Provisional Patent Application No. 61/799,712, filed on Mar. 15, 2013, the disclosure of which is incorporated herein in its entirety by reference.

### BACKGROUND

1. Technical Field

The present invention is directed to fittings for electrical conduit, and in particular, to electrical fittings which may be easily placed over conduit and secured in place.

2. Background

The installation of the fittings for conduit typically requires that installer carefully place a fitting onto the conduit, and once the fitting is in place, to secure the fitting in place with some form of locking device, such as by tightening a screw. These steps require installation time, and provide substantial opportunity for human error.

For example, in order for a fitting comprising a screw that must be tightened to be secured in place, the step of tightening the screw must be performed. If the screw is not tightened, the fitting is not secure, and the conduit potentially could come out of its fitting. This installation process creates a substantial risk of human error, and a potential resulting danger to the public. For example, this method presents the potential for human error in improperly tightening the screw, or even potentially simply forgetting to tighten it. In a busy work environment with many distractions abounding, it is possible that in a moment of distraction, tightening a screw on even a single fitting could be overlooked, leaving the conduit subject to movement or even potentially breaking free from the fitting, endangering the surrounding environment.

A conduit that has not been properly secured in a fitting can be quite dangerous, because if the electrical wiring routed through said conduit comes in contact with a person, the electrical current being transmitted through the electrical wiring could be transmitted to a person, which potentially could result in substantial bodily injury or even death.

Electrical conduit is widely used in the construction industry. Such conduit protects electrical wiring from exposure to the immediate environment and potential sources of damage. Said conduit also protects people, animals and property from exposure to danger and potential harm from the electrical wiring within the conduit.

The standard way electrical conduit is installed is by providing segments of conduit, and connecting them to each other and to other things such as electrical boxes. In order to connect the pieces of conduit to each other or to other things, it is standard practice to use some form of fitting. Fittings include couplings, which join pieces of conduit together, and connectors which are used to join a piece of conduit to something else, such as an electrical box.

It would be desirable to provide an improved electrical fitting which is simple to manufacture, and easy to install. The electrical conduit fitting of the present invention would enable an electrical fitting to more quickly and easily be installed, while at the same time reducing the potential for human error. The electrical conduit fitting of the present invention should overcome the deficiencies of the presently available methods and systems available for installation of electrical conduit.

Known methods of affixing fittings to conduit include the aforementioned screw method. It also is known to use a conduit system wherein a plain end of conduct is inserted into a second piece of conduit until fully seated, wherein said second piece of conduit has a gland, and a nut which may be tightened, for example, with pliers or a wrench until it is snug. Such a conduit fitting system comprising a gland nut which may be tightened is the Allied Kwik-Fit Compression™ EMT.

### SUMMARY

The present invention relates to an electrical conduit fitting which includes a cylindrical portion, having an inside surface and an outside surface. Also, at least one tapered end tapers outwardly such that the circumference of the tapered end is larger than the circumference of the outside surface of the cylindrical portion. To retain the conduit in the fitting, a spring band is affixed (or integral) to the cylindrical portion and to the tapered portion of the fitting to hold the conduit in the fitting once the fitting is inserted.

According to the present invention, the outwardly tapering spring band may be integrally manufactured with the cylindrical tapering end portion or portions, such that the fitting is composed of one integral unit. Alternatively, the spring band may be manufactured of the same or a different material, and joined to the cylindrical portion and to the tapering portion of the cylindrical member.

In certain embodiments, the spring band can be configured such that it has longitudinally positioned slits to further facilitate resiliency.

In additional embodiments of the present invention, the electrical conduit fitting may be used in conjunction with conduit having a groove, into which the spring band may spring once the fitting and conduit are assembled, further securing the combined fitting and conduit.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like referenced characters denote corresponding parts through the several views and wherein:

FIGS. 1A-B illustrate a side view and end view of the electrical conduit coupling having conduit located within the fitting;

FIG. 2 illustrates a side view of a connector fitting have a conduit located within the connector; and

FIG. 3 illustrates an end view of a spring band having longitudinal slits.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

One exemplary embodiment of the present invention will now be described below.

In particular, FIGS. 1A-B illustrate one exemplary embodiment of the present invention in which an electrical conduit fitting 100 in this embodiment is in the form of a coupling which is structured to receive conduit 112a,b on two ends thereof (102a, b, respectively). However, it should be understood by those skilled in the art that although the fitting shown in FIGS. 1A-B is represented as a coupling, the present invention is not limited to such and instead the fitting could be integrated into an end of a conduit so that the fitting has only one receiving end as shown in FIGS. 2A-B (discussed below).

More specifically, FIGS. 1A-B includes two receiving ends 102a, b that are generally minor images of each other. As such reference will only be made to one of the receiving ends, however, it is understood that both receiving have the same elements and as such discussion of these like elements would be repetitive in nature. Notably, the two receiving ends 102a, b may have different dimensions, such as different inner diameters, such as to provide a coupling between two differently sized conduits 112a, b, respectively.

According to the illustrative embodiment shown in FIGS. 1A-B, each receiving end 102a, b includes a tapered end or ends 104 that resiliently affix a respective insertion element 112a,b, e.g., an adjoining electrical conduit or electrical equipment such as a connector box into the fitting. More specifically, the electrical conduit fitting 100, referred to herein as a “fitting,” according to the exemplary embodiment of the present invention, includes a generally cylindrical portion, having an inside surface that may come in contact with the insertion element 112 and an outside surface, and an end or ends 104 tapered outwardly such that said ends taper out to a circumference that is larger than the circumference of the cylindrical portion. The fitting may also include an inwardly tapering spring band 108, connected to the outwardly tapering portion of the fitting.

The fitting 100 may also include an internally located stopper 106 disposed on an end of the fitting opposite the receiving ends 104, and in the case of a coupling fitting like the one shown in FIGS. 1A-B, the stopper 106 may be disposed in a generally centered portion of the fitting to allow the insertion elements 112 to only be inserted into the fitting a given distance set by the stopper 106.

Furthermore, according to the present invention, the inwardly tapering spring band 108 may be integrally manufactured with the cylindrical tapering end portion or portions 104, such that the fitting is composed of one integrated unit. Alternatively, the spring band 108 may be manufactured of the same or a different material, and joined to the cylindrical portion and to the tapering portion of the cylindrical member. The spring band aids in retaining the insertion element (e.g., conduit) within the fitting after the insertion element 112 has been inserted by forcing the insertion element ends to compressibly insert into the fitting 100. The compressive force of the spring band 108 is sufficient to generally prevent the insertion element from being removed easily from the fitting 100.

Furthermore, as discussed above, the fitting may also be integrated into an insertion element itself so that the fitting has a singular receiving end. FIG. 2 provides an exemplary embodiment of the present invention which depicts a fitting 200 in accordance with an exemplary embodiment of the present invention in which the fitting is integrated into an insertion element 214 (e.g., an electrical box) so that an adjoining insertion element 212 (e.g., a conduit) may be inserted into the receiving end 204 of the fitting 200.

Like in the fitting depicted in FIGS. 1A-B, the structure of the receiving end of the fitting 200 may be generally identical to the structure of the receiving end of the fitting 100 and thus, the description of the spring band 208, and the stopper 206 will be omitted to avoid repetition.

Notably, in certain embodiments, the spring band 108 or 208 can be configured such that it has longitudinally positioned slits to even further facilitate resiliency, such as shown in FIG. 3. These slits increase the flexibility of the spring band and allow the band to provide a more resilient force to the insertion element 112 or 212.

In additional embodiments of the present invention, the electrical conduit fitting may be used in conjunction with conduit having a groove (not shown), into which the spring band may spring once the fitting and conduit are assembled, further securing the combined fitting and conduit (e.g., a cylindrical snap fitting).

The invention has been described in detail with reference to preferred exemplary embodiments thereof. However, it will be appreciated by those skilled in the art that changes may be made in these embodiments without departing from the principles and spirit of the invention, the scope of which is defined in the appended accompanying claims and their equivalents.

What is claimed is:

1. A fitting, comprising:
a cylindrical portion, having an inside surface and an outside surface;
at least one tapered end tapering outwardly such that the circumference of the tapered end is larger than the circumference of the outside surface of the cylindrical portion; and
an inwardly tapered spring band affixed to the cylindrical portion and to the tapered portion of the fitting.

2. The fitting of claim 1, wherein the spring band is integrally formed with the tapered portion of the fitting.

3. The fitting of claim 1, wherein the fitting comprises one tapered end and corresponding spring band.

4. The fitting of claim 1, wherein the fitting comprises two tapered ends, wherein each of said tapered ends is affixed to a corresponding spring band.

5. The fitting of claim 1, wherein the fitting is composed of metal.

6. The fitting of claim 1, wherein the spring band comprises longitudinally positioned slits.

7. A method for assembling electrical conduit, the method comprising:
providing an electrical fitting, the fitting comprising a cylindrical portion having an inside surface and an outside surface, and at least one tapered end tapering outwardly such that the circumference of the tapered end is larger than the circumference of the outside surface of the cylindrical portion, and a spring band affixed to the cylindrical portion and to the tapered portion of the fitting.

8. The method of claim 7, further comprising:
providing a conduit having a groove located such that when the conduit is inserted into the fitting, the spring band enters the groove.
